(19) United States
(12) Patent Application Publication
(10) Pub. No.: US 2010/0095315 A1
(43) Pub. Date: Apr. 15, 2010

(54) STORAGE MEDIUM PLAYBACK DEVICE

(75) Inventors: Kei Shirahata, Chiyoda-ku (JP); Shigeki Asai, Chiyoda-ku (JP); Takao Morimoto, Chiyoda-ku (JP); Masayoshi Takehata, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: Mitsubishi Electric Corporation

(21) Appl. No.: 12/515,355

(22) PCT Filed: Nov. 29, 2007
(86) PCT No.: PCT/JP2007/073097

§ 371 Date: Dec. 24, 2009

(30) Foreign Application Priority Data
Dec. 22, 2006 (JP) 2006-345388

(51) Int. Cl. G11B 17/04

(52) U.S. Cl. 720/642; G9B/17.013

(57) ABSTRACT

Problem: A storage medium playback device includes a first playback means that plays back on the basis of information stored on a storage medium, a second playback means that plays back on the basis of information stored on a storage medium, and a single insertion slot through which a storage medium to be played back by the first playback means and a storage medium to be played back by the second playback means are inserted, wherein the storage playback device is capable of simultaneously playing back different storage media each with the first playback means and the second playback means; therefore, the area of an installation face for insertion slots is effectively used.

Solution: The storage medium playback device includes a first playback means that plays back on the basis of information stored on a storage medium, a second playback means that plays back on the basis of information stored on a storage medium, and a single insertion slot through which a storage medium to be played back by the first playback means and a storage medium to be played back by the second playback means are inserted, wherein the storage playback device is capable of simultaneously playing back different storage media each with the first playback means and the second playback means.

### TECHNICAL FIELD

The present invention relates to storage medium playback devices, each capable of simultaneously playing back two storage media, and especially relates to a storage medium playback device capable of simultaneously playing back two discs including CDs, DVDs and the like with two playback units.

### BACKGROUND ART

As has been described in Patent document 1, a storage medium playback device of this kind includes two playback units each playing back different kinds of discs-3.5-inch discs and 5-inch discs—and includes insertion slots for 3.5-inch and 5-inch discs, which correspond to the respective playback units.

Patent Document Japanese Patent Laid-Open No. H1-150271 (FIG. 1)

### DISCLOSURE OF THE INVENTION

As has been described in Patent document 1, a conventional storage medium playback device includes two playback units, each playing back different kinds of discs-3.5-inch discs and 5-inch discs—and includes a plurality of insertion slots for 3.5-inch discs and 5-inch discs, which correspond to the respective playback units; thus, when a display area is provided on a surface where insertion slots are formed, a problem has been that, the more insertion slots to be installed, the more difficult to secure areas for the installation.

There has also been a problem that increasing the number of insertion slots allows dust to easily enter the devices, causing malfunctions and the like.

Moreover, because two playback units are independent from each other, no components can be shared therebetween, which has brought a problem that it is difficult to reduce costs and save space.

An exemplary embodiment of the present invention can solve the problems described above, and can provide a device that is capable of simultaneously playing back a plurality of discs and effectively using an area of an installation face for insertion slots, by being provided with a single insertion slot as a shared insertion slot for a plurality of discs and simultaneously playing back a plurality of discs inserted through the insertion slot with a plurality of playback means in the device.

A storage medium playback device according to an exemplary embodiment of the present invention includes: a first playback means that plays back on the basis of information stored on a storage medium; a second playback means that plays back on the basis of information stored on a storage medium; and a single insertion slot through which a storage medium to be played back by the first playback means and a storage medium to be played back by the second playback means are inserted; wherein the storage medium playback device is capable of simultaneously playing back different storage media each with the first playback means and the second playback means.

According to an exemplary embodiment of the present invention, a storage medium playback device is configured in a manner that the device includes a first playback means that plays back on the basis of information stored on a storage medium, a second playback means that plays back on the basis of information stored on a storage medium, and a single insertion slot through which a storage medium to be played back by the first playback means and a storage medium to be played back by the second playback means are inserted, wherein the storage medium playback device is capable of simultaneously playing back different storage media each with the first playback means and the second playback means; therefore, the area of an installation face for insertion slots is effectively used.

### BRIEF DESCRIPTION OF DRAWINGS

FIG. 1 is a side view outlining the structure of a storage medium playback device;

FIG. 2 is a top view outlining the structure of the storage medium playback device;

FIG. 3 is a view illustrating how relevant parts operate in the structure outlined by FIG. 1;

FIG. 4 is another view illustrating how relevant parts operate in the structure outlined by FIG. 1;

FIG. 5 is another view illustrating how relevant parts operate in the structure outlined by FIG. 1;

FIG. 6 is another view illustrating how relevant parts operate in the structure outlined by FIG. 1;

FIG. 7 is another view illustrating how relevant parts operate in the structure outlined by FIG. 1;

FIG. 8 is a top view illustrating how components inside the playback device operate at the operation state shown in FIG. 7;

FIG. 9 is another view illustrating how relevant parts operate in the structure outlined by FIG. 1;

FIG. 10 is a perspective view illustrating an exterior appearance of the storage medium playback device;

FIG. 11 is a perspective view taken from a right-front side of the device with its top board being removed to show its inside;

FIG. 12 is a perspective view taken from a right-front side of the device with its top board, front board and right side board being removed to show its inside;

FIG. 13 is a perspective view of the device's top board when it is upside down;

FIG. 14 is a perspective view taken from a right-front side of the device with its top board being removed to show its inside;

FIG. 15 is a left side view showing how relevant parts of the device operate;

FIGS. 16A and 16B illustrate developments of surfaces of relevant parts of the device;

FIG. 17 is an operation transition table that shows how relevant parts of the device operate in accordance with respective operational modes;

FIG. 18 is another left side view showing how relevant parts of the device operate;

FIG. 19 is another left side view showing how relevant parts of the device operate;

FIG. 20 is another left side view showing how relevant parts of the device operate;

FIG. 21 is another left side view showing how relevant parts of the device operate;

FIG. 22 is another left side view showing how relevant parts of the device operate;

FIG. 23 is another left side view showing how relevant parts of the device operate;

FIG. 24 is another left side view showing how relevant parts of the device operate;

FIG. 25 is another left side view showing how relevant parts of the device operate.

### REFERENCE NUMERALS

100 deck chassis
101 insertion slot
102 top board
200 upper playback unit
201 pick-up member
202 turntable
204 dampers
205 upper playback base
210 swing base
211 pivoting base
212 pivot
213 swing base
220 swing mechanism
225 swing lever
300 lower playback unit
301 pick-up member
302 turntable
304 damper
305 lower playback base
400 disc carrier tray unit (holding means)
410 upper-playback disc carrier tray
411 leaf spring
412 leaf spring
420 lower-playback disc carrier tray
421 leaf spring
422 leaf spring
500 movement mechanism
510 first screw members
5101-5103 cam-groove horizontal section
5104-5105 cam-groove horizontal section
5111-5113 cam-groove horizontal section
520 second screw member
5201-5203 cam-groove horizontal section
5204-5205 cam-groove horizontal section
5211-5213 cam-groove horizontal section

### BEST MODE FOR CARRYING OUT THE INVENTION

In order to describe exemplary embodiments of the present invention in more detail, the best mode for carrying out the invention will be explained below, using the attached drawings.

### Embodiment 1

In Embodiment 1, first, there will be explained an overall general configuration and operations of the storage medium playback device, and then components and operations thereof will be explained.

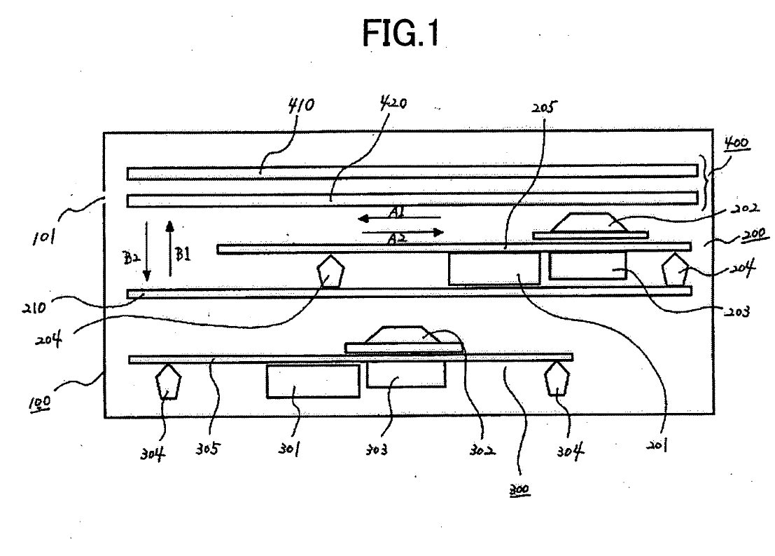

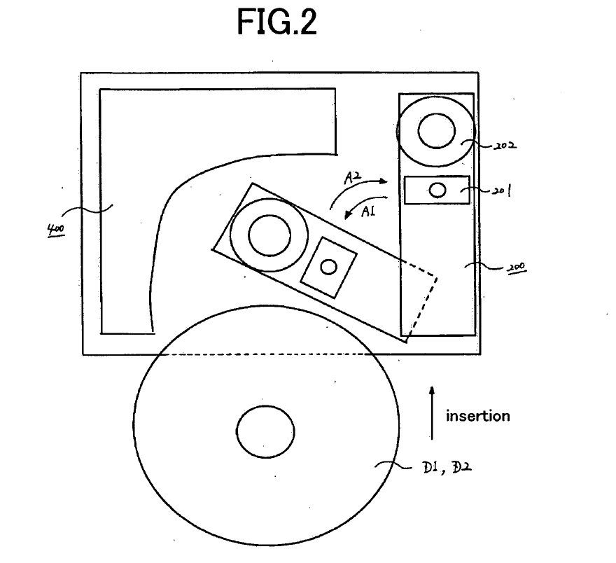

FIG. 1 and FIG. 2 are drawings that outline a structure of a storage medium playback device of Embodiment 1 according to the present invention.

FIG. 1 is a side cross-sectional view of the storage medium playback device, and FIG. 2 is a top cross-sectional view thereof.

The views show that a disc playback device according to an exemplary embodiment of the present invention includes a deck chassis 100, an upper playback unit 200, a lower playback unit 300, and a disc carrier tray unit 400.

The deck chassis 100 is a housing, and by cutting out a portion of the deck chassis 100 an insertion slot 101 is formed, through which discs—as storage media—are inserted into and ejected from the device.

An upper playback unit 200 serves as a first playback means that plays back a disc inserted through the insertion slot 101, and the upper playback unit is configured with a pick-up member 201 that reads out information on the disc, a turntable 202 that rotates with the disc placed thereon, a driving member 203 that drives the turntable 202 to rotate, a swing base 210 that is included in the upper playback unit 200 and pivotally moves the upper playback unit 200 in a direction A1 and a direction A2, an upper playback base 205 on which the pick-up member 201, the turntable 202, and the driving member 203 are placed, and dampers 204 that serve as vibration isolators.

When not playing back, the swing base 210 engages with the upper playback base 205 through a locking member (not shown in the figures), and when playing back, they are joined through the dampers 204. The upper playback unit 200 is structured so that the unit can pivotally move in approximately the same plane as a surface of the disc in the direction A1 and in its reverse direction A2; and when playing back the disc, the unit pivotally moves in the direction A1, and when not playing back the disc, it rotates in the direction A2.

The lower playback unit 300 is placed as a second playback means below the upper playback unit 200 so as to play back a disc inserted through the insertion slot 101, and the lower playback unit includes—similarly to the upper playback unit 200—a pick-up member 301 that reads out information stored on the disc, a turntable 302 that rotates with the disc placed thereon, a driving member 303 that drives the turntable 302 to rotate, a lower playback base 305 on which the pick-up member 301, the turntable 302, and the driving member 303 are placed, and dampers 304 that serve as vibration isolators for the lower playback unit 300, and a portion of each damper 304 is fixed to the bottom portion of the deck chassis 100 so that the lower playback unit 300 is placed not to pivotally move unlike the upper playback unit 200.

When not playing back, the deck chassis 100 engages with the lower playback base 305 through a locking member (not shown in the figures), and when playing back, they are joined through the dampers 304.

The disc carrier tray unit 400 serves as a holding means that holds a disc when neither the upper playback unit 200 nor the lower playback unit 300 is playing back the disc, and the tray unit has a movement mechanism that moves the disc perpendicularly to a surface of the disc being played back according to operation states of the upper playback unit 200 and the lower playback unit 300; and the disc carrier tray unit 400 includes an upper-playback disc carrier tray 410 that serves as a first tray to carry a disc D1 to be played back at the upper playback unit 200, and a lower-playback disc carrier tray 420 that serves as a second tray to carry a disc D2 to be played back at the lower playback unit 300.

The disc carrier tray unit 400 is structured so that it can be moved by the movement mechanism in a direction B1 and a direction B2 shown in FIG. 1, and the upper tray 410 and the lower tray 420 move upward (in the direction B1) and downward (in the direction B2). The discs D1 and D2 are being carried.

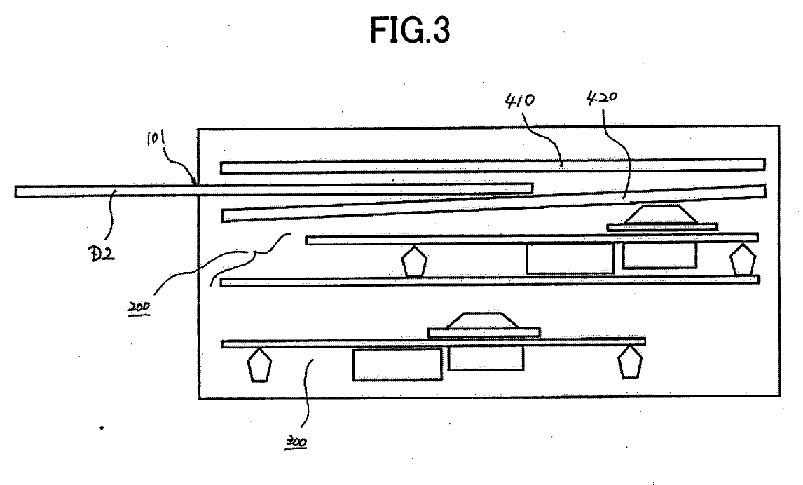

FIG. 3 shows a state in which the disc D2 is placed on the lower tray 420 in order to be played back at the lower playback unit 300.

The figure also shows a state in which the disc D2 is being carried and the lower tray 420 tilts its insertion slot's side down so that the disc D2 can easily be placed on the lower tray 420.

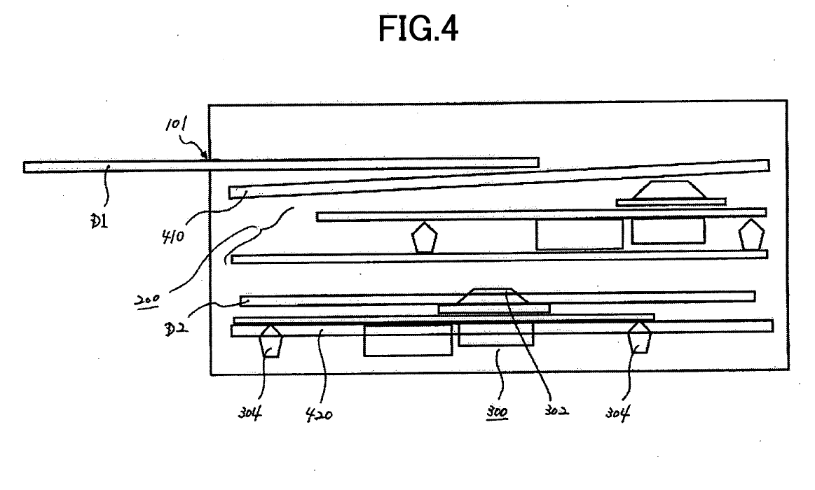

Next, FIG. 4 shows a state in which the disc D2 is loaded on the lower playback unit 300 to be played back, and in which for playing back the disc D1 at the upper playback unit 200, the upper tray 410 tilts its insertion slot's side down so that the disc D1 can be easily placed on the tray.

The figure shows that the lower tray 420 on which the disc D2 is placed moves downward from the state shown in FIG. 3, so as to place the disc D2 on the turntable 302, and the lower tray 420 further moves downward, then the tray is set apart from the disc D2 and the lower playback unit 300.

By the above-described operations, the lower playback unit 300 is connected only to the deck chassis 100 through the dampers 304 that transmit less external vibrations, so that the unit is completely separated from the lower tray 420.

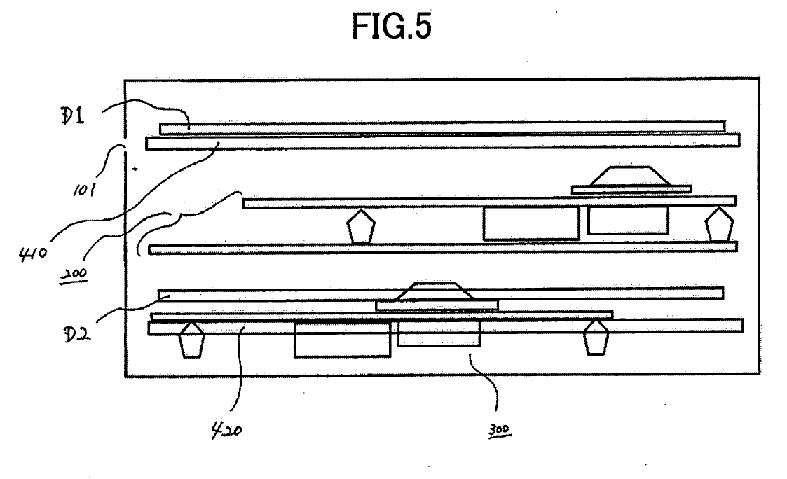

FIG. 5 shows a state in which the upper tray 410 holds the disc D1 to play back the disc D1 at the upper playback unit 200.

Because the disc D1 is held on the upper tray 410 through the operations illustrated in FIG. 4, the upper tray 410 is returned from the state in which the tray tilts down its side of the insertion slot 101 to the original state in which the tray is parallel to the lower tray 420.

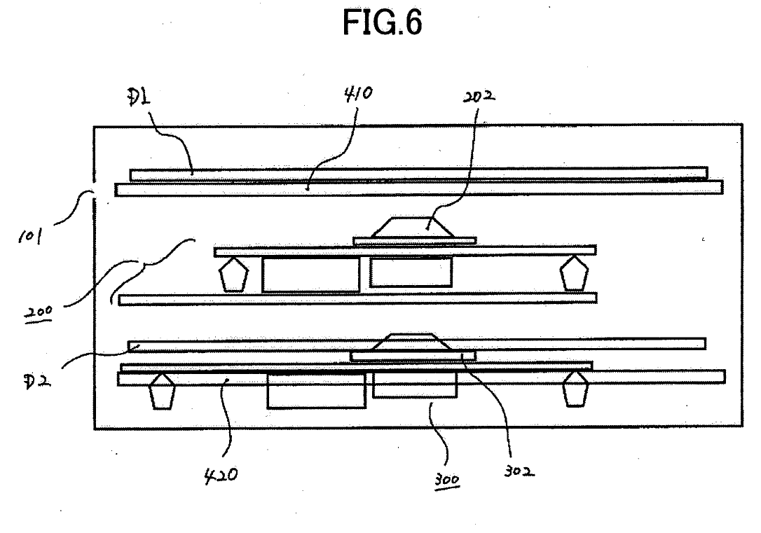

FIG. 6 shows a state in which the upper playback unit 200 has pivotally moved for playback to a playback position from a position where the unit was previously moved to be near a side wall of the deck chassis 100.

The figure shows that, while the upper tray 410 on which the disc D1 is placed remains in a state in which the tray has moved upward as shown in FIG. 5, the turntable 202 of the upper playback unit 200 has pivotally moved on the same plane as the disc surface so as to be positioned coaxially with the turntable 302 of the lower playback unit 300.

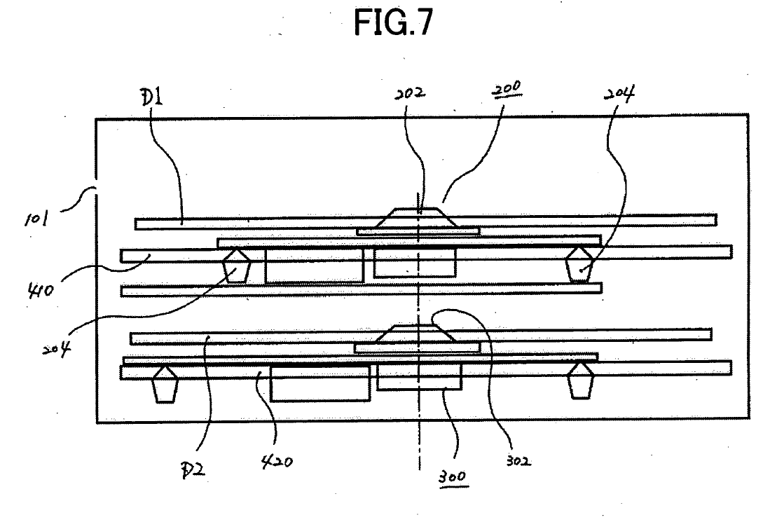

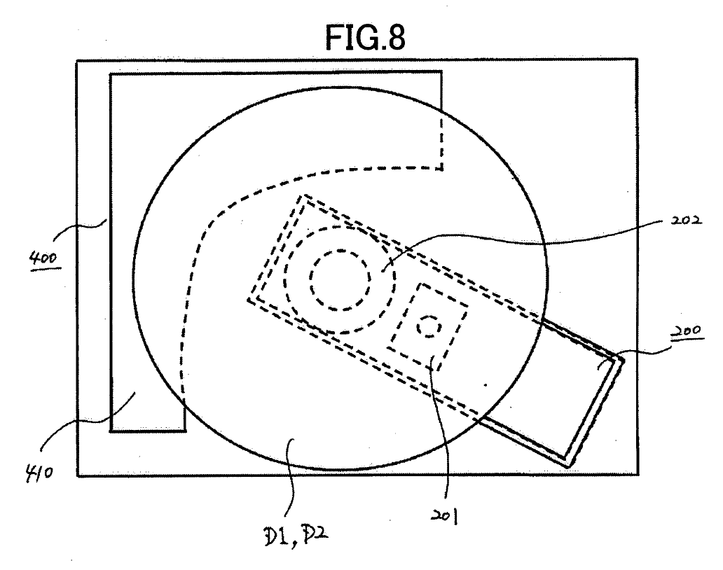

FIG. 7 shows a state in which the upper playback unit 200 is playing back the disc D1, and FIG. 8 is a top cross-sectional view when the device is in the state shown in the FIG. 7.

The figures show that the upper tray 410 on which the disc D1 is placed moves downward to place the disc D1 on the turntable 202, and then the upper tray 410 further moves downward, so that the tray is set apart from the disc D1 and the upper playback unit 200.

By the above-described operations, the swing base 210 is connected only to the upper playback base 205 through the dampers 204 that transmit less external vibrations, so that the base is completely separated from the upper tray 410.

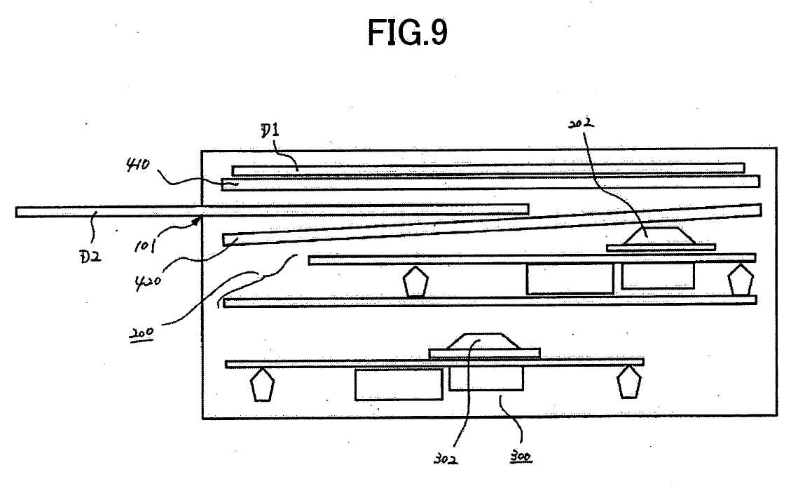

FIG. 9 shows a state in which the disc D2 placed on the turntable 302 of the lower playback unit 300 is being ejected; with the disc D1 being placed on the upper tray 410, the lower tray 420 is moved upward to a level shown in FIG. 3 to eject the disc D2.

In order that a conveyance path for ejecting the disc D2 is secured when the disc D2 is to be ejected, the upper playback unit 200 is structured so that the playback operation by the upper playback unit is interrupted and then the upper tray 410 is moved upward in the deck chassis 100 together with the disc D1.

In order to output a playback signal for a predetermined period even when the playback operation by the upper playback unit is interrupted, a shock proof memory is provided as a storage means; and, after the disc D2 is ejected, the upper tray 410 is moved downward to a level shown in FIG. 7, which enables the upper playback unit 200 to continue playing back.

In addition, a small capacity of the shock proof memory is applicable if the data capacity of the disc D1 is small; thus, taking into account the data capacity difference between disc types, a disc to be played back at the lower playback unit 300 has a large amount of capacity such as a DVD, and a disc to be played back at the upper playback unit 200 is a CD or the like that has a capacity smaller than that of a large capacity medium such as a DVD, which configuration makes the playback device less expensive and enables the device to keep outputting a playback signal being produced from the upper playback unit 200 without interruption even while a disc placed on the lower playback unit 300 is being ejected.

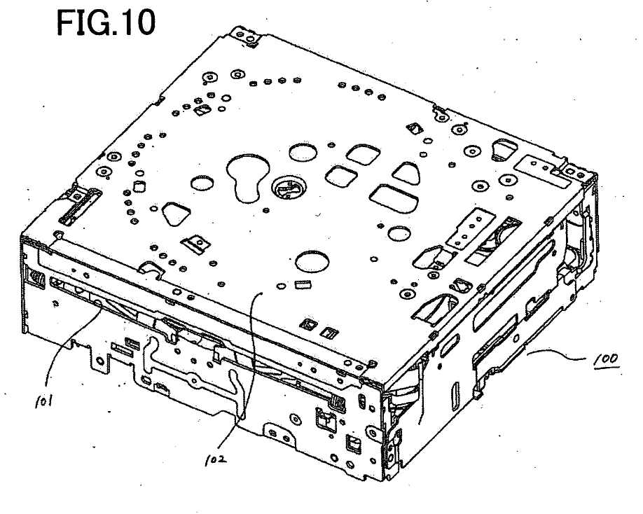

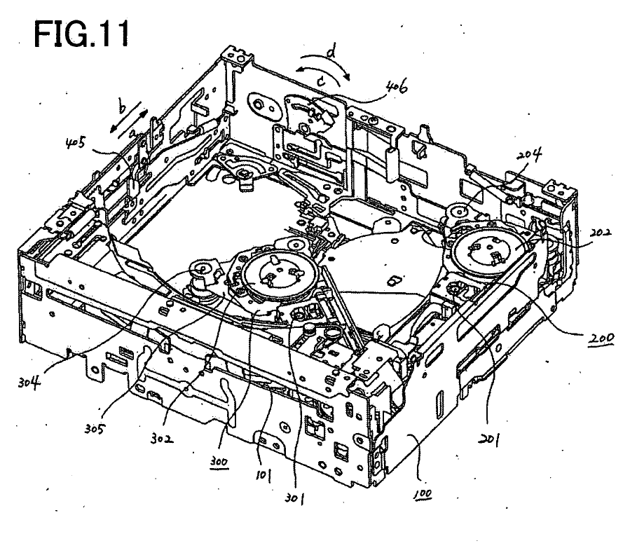

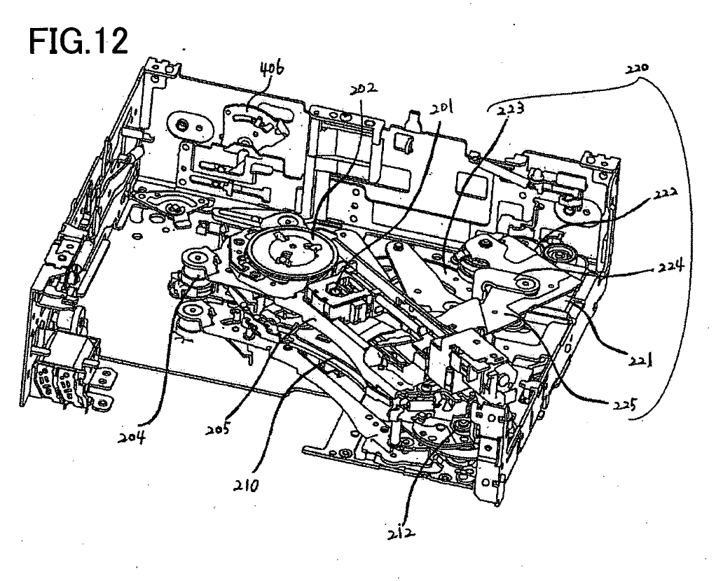

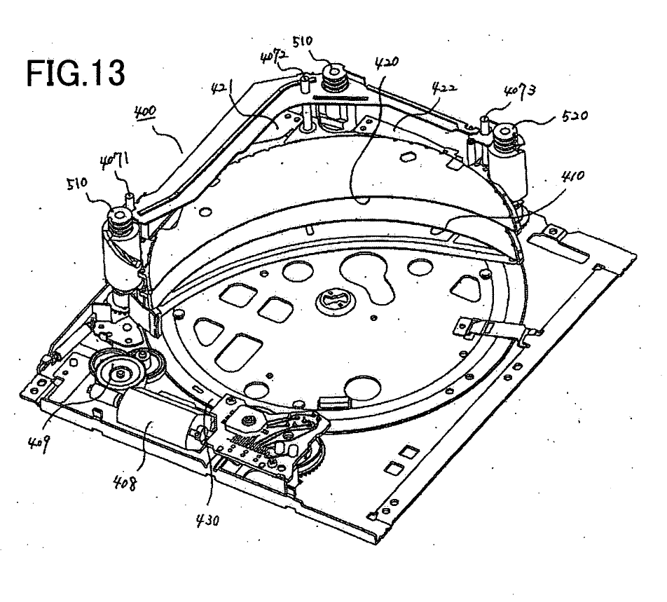

Fundamental configurations and operations of the storage medium playback device have been described above, thus detailed configurations and operations thereof will be explained below. FIG. 10 is an overall perspective view illustrating the playback device; FIG. 11 is another perspective view of the playback device that illustrates relevant components when a top board 102 of the deck chassis 100 of the playback device is removed; FIG. 12 is another perspective view of the playback device that illustrates relevant components when the front face and the right side face of the deck chassis 100, shown in FIG. 11, are detached; FIG. 13 is an inside perspective view of the top board 102 of the deck chassis 100, illustrating relevant components.

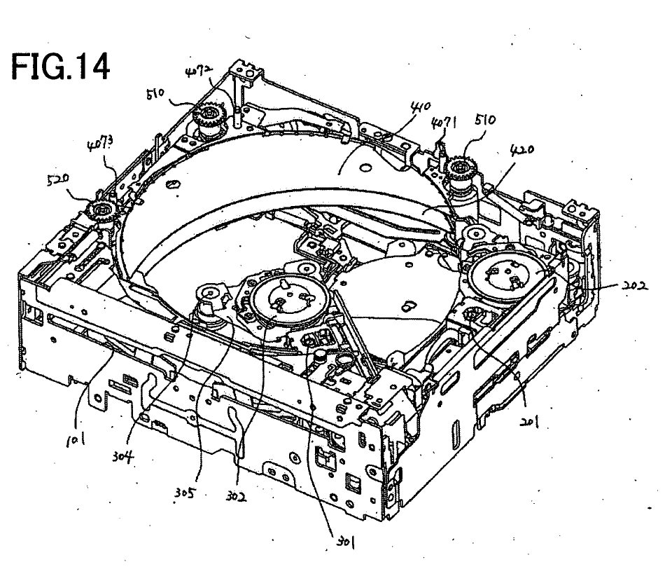

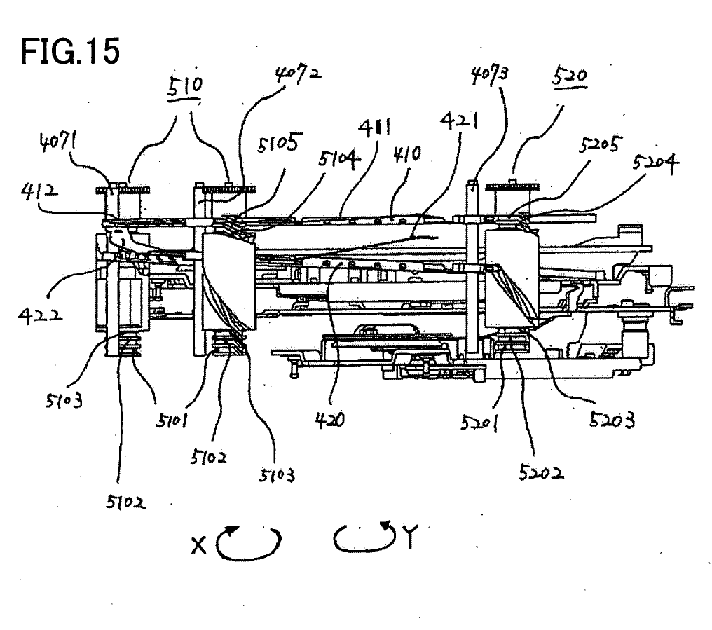

FIG. 14 is a perspective view that shows connections between relevant components shown in FIG. 11 and FIG. 13; FIG. 15 is a side view illustrating relevant components such as holding means and movement mechanisms.

In the figures, the deck chassis 100 serves as a housing, the upper playback 200 serves as a first playback means, and the lower playback unit 300 serves as a second playback means.

The lower playback unit 300 includes the pick-up member 301 that reads out data on a disc, the turntable 302 that rotates the disc during playing back by a driving force of the driving member 303, the lower playback base 305 that supports the pick-up member 301 and the turntable 302, and the dampers 304 that prevent external vibrations from being transmitted to the lower playback base 305, and the dampers 304 are fixed to the deck chassis 100.

In the upper playback unit 200, a pivot 212 is provided on the deck chassis 100 in order to pivotally move the upper playback unit 200 in both directions A1 and A2 shown in FIG. 2. The upper playback unit 200 includes the turntable 202 that rotates the disc during playing back, the pick-up member 201 that reads out disc data, the upper playback base 205 that supports the turntable 202 and the pick-up member 201, the swing base 210 that engages with the pivot 212 and pivotally moves the upper playback base 205 through a locking member (not shown in the figures), and the dampers 204 that prevent external vibrations from being transmitted to the upper playback base 205; and the dampers 204 are fixed to the swing base 210.

A swing mechanism 220 engages with the swing base 210 and pivotally moves the upper playback base 205 in the directions A1 and A2 shown in FIG. 2; the swing mechanism 220 includes a motor 221, a gear set 222 that transmits driving force of the motor 221, a cam gear 223 that engages with the gear set 222, a lever 224 that engages with the cam gear 223, and a swing lever 225 that engages with the lever 224 and the swing base 210, to swing the upper playback unit 200.

The disc carrier tray unit 400 serves as a holding means that is constructed in the inner side of the top board 102 of the deck chassis 100; and the disc carrier tray unit 400 includes a movement mechanism 500 that moves, according to operation states of the upper playback unit 200 and the lower playback unit 300, a disc to be played back at the upper playback unit 200 and a disc to be played back at the lower playback unit 300 in directions—the directions B1 and B2 shown in FIG. 2—perpendicular to a surface of a disc in a playback state.

The disc carrier tray unit 400 includes the upper-playback disc carrier tray 410 that carries and holds a disc to be played back at the upper playback unit 200, the lower-playback disc carrier tray 420 that carries and holds a disc to be played back at the lower playback unit 300, leaf springs 411 and 412 that are fixed at the upper tray 410 to hold a disc placed on the upper tray 410, and leaf springs 421 and 422 that are fixed at the lower tray 420 to hold a disc placed on the lower tray 420.

Except while the discs are being played back or being inserted, the leaf springs 411, 412, 421, and 422 are energized to hold the discs.

The disc carrier tray unit 400 includes: plates 405 and 406 that move the leaf springs 411, 412, 421, and 422 upward during playing back and inserting discs by movement of the cam gear 223 shown in FIG. 12 through a link (not shown in the figures); first screw members 510, serving as the movement mechanism 500 to move the disc carrier tray unit 400 in the directions B1 and B2 shown in FIG. 2, each of which engages with convex portions of the upper tray 410 and the lower tray 420 and rotates to change the height positions of the tray 410 and the tray 420; and a second screw member 520, serving as the movement mechanism 500 to move the disc carrier tray unit 400 in the directions B1 and B2 shown in FIG. 2, that engages with convex portions of the upper tray 410 and the lower tray 420 and rotates to change the height positions of the tray 410 and the tray 420.

The upper tray 410 and the lower tray 420 are formed in a crescent shape, and the first screw members 510 are placed at two positions further inner and away from the insertion slot and the second screw member 520 is placed closer to the insertion slot than the first screw members 510; the second screw member 520 has a cam-shaped portion different from that of the first screw members 510 so as to perform disc insertion guiding, in which when inserting a disc the disc-insertion-slot sides of the disc carrier tray 410 and the disc carrier tray 420 are tilted down for easy disc insertion.

The disc carrier tray unit 400 includes guide bars 407 that stabilize upward/downward movements—movements in the directions B—of the upper tray 410 and the lower tray 420, and as the guide bars 407 three guide bars 4071 through 4073 are provided close to the first screw members 510 and the second screw member 520.

The disc carrier tray unit 400 also includes a motor 408 that rotates the first screw members 510 and the second screw member 520, a gear set 409 that transfers driving force of the motor 408, and a ring gear 430 that engages with the gear set 409 to transfer driving force to the first screw members 510 and the second screw member 520 and synchronize rotations of the three screw members—the first screw members 510 and the second screw member 520.

Next, the movement mechanism 500 will be explained.

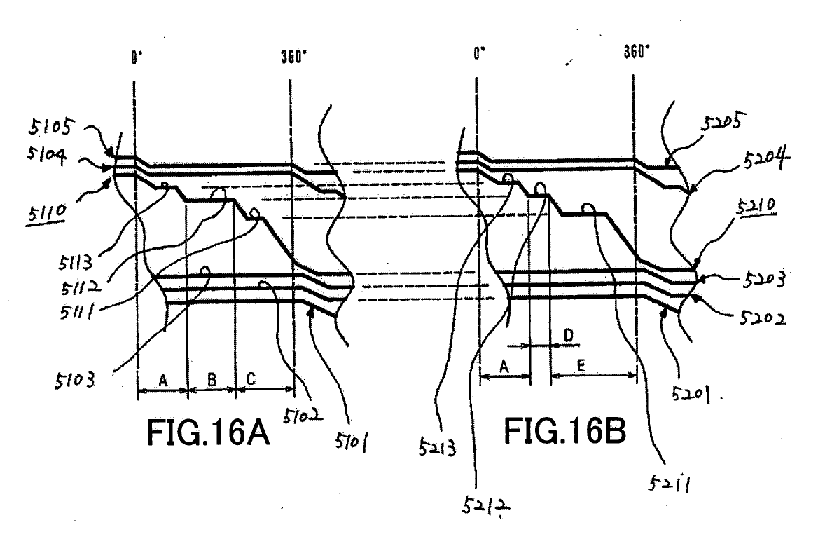

FIGS. 16A and 16B illustrate relevant portions of the first screw members 510 and the second screw member 520 that serve as the movement mechanism 500.

FIG. 15 shows that at lower ends (in the bottom side of the figure) of the first screw members 510 and the second screw member 520 serving as the movement mechanism 500, cam-groove horizontal sections 5101, 5102, 5103 and 5201, 5202, 5203 are formed as three lower horizontal grooves on the respective screw members; and at upper ends (in the top side of the figure) of the first screw members 510 and the second screw member 520, cam-groove horizontal sections 5104, 5105 and 5204, 5205 are formed as two upper horizontal grooves on the respective screw members.

In order to perform disc insertion guiding when a disc is inserted, there are differences, in cam groove shapes of the first screw members 510 and the second screw member 520, between the cam groove horizontal sections 5104, 5105 and 5204, 5205 and between the cam groove horizontal sections 5101, 5102, 5103 and 5201, 5202, 5203.

FIGS. 16A and 16B illustrate specific relations between rotation angles (rotation zone) of the screw members and heights of the cam grooves.

FIGS. 16A and 16B illustrate developments of outer circumference surfaces—in which cam shapes are formed—of each of the first screw members 510 and the second screw member 520. FIG. 16A illustrates a development of a surface of the first screw members 510 and FIG. 16B illustrates a development of a surface of the second screw member 520.

The cam-groove horizontal sections 5101 through 5105 of each first screw member 510 are positioned at the same height as the cam-groove horizontal sections 5201 through 5205 of the second screw member 520, respectively; however, the starting angle of a range C (left extremity of the range in the figure) of the cam-groove horizontal section 5110 existing in a central region of each first screw member 510 differs from that of a range E (left extremity of the range in the figure) of the cam-groove horizontal section 5210 existing in a central region of the second screw member 520.

Here, ranges A through E are rotation angles (rotation ranges); the ranges A, B, and C are formed in that order as a positional angle of each first screw member 510 increases from 0 degrees to 360 degrees, and the ranges A, D, and E are formed in that order as a positional angle of the second screw member 520 increases from 0 degrees to 360 degrees.

The lengths of the ranges A of each first screw member 510 and the second screw member 520 are equal, and other ranges are formed to satisfy relational expressions below.
(1) range B+range C=range D+range E
(2) range B>range D
(3) range E>range C

Rotation start positions of the first screw members 510 and the second screw member 520 are the same; when the screws rotate in a direction from 0 degrees to 360 degrees so that the convex portions of the upper tray 410 and the lower tray 420, engaging with the first screw members 510, are reaching to the end portion of the range B—a cam-groove horizontal section 5112, the convex portions of the upper tray 410 and the lower tray 420, engaging with the second screw member 520, fall to a flat portion in the range E of the second screw member 520—a cam-groove horizontal section 5211.

Therefore, at that rotational position, the upper tray 410 and the lower tray 420 can be tilted.

In each middle portion of the first screw members 510 and the second screw member 520, there is a cam groove formed with three horizontal portions having different height levels; the heights of the cam-groove horizontal sections 5111, 5112, 5113 are the same as those of the cam-groove horizontal sections 5211, 5212, 5213, respectively; the first screw members 510 and the second screw member 520 are formed in such a way that the starting end of the cam-groove horizontal section 5111 is formed, in rotation angle, differently from that of the cam-groove horizontal section 5211.

Next, operations of the device according to exemplary embodiments of the present invention will be explained.

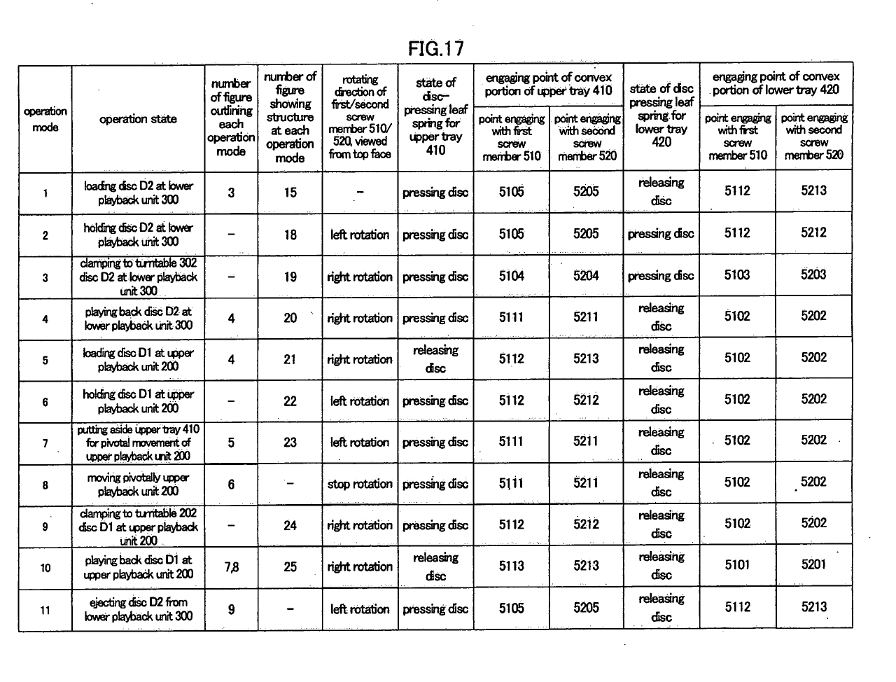

FIG. 17 is an operation transition list which shows, in each of operation modes (1) through (11) to be described below, positional relations between the upper tray 410 and the lower tray 420 and the first screw members 510 and the second screw member 520, operation states of other components and the like.

<Operation Mode>
(1) inserting a disc D2 to be played back at the lower playback unit 300 (loading)
(2) holding the disc D2 to be played back at the lower playback unit 300
(3) placing onto the turntable 302 the disc D2 to be played back at the lower playback unit 300 (clamping)
(4) playing back the disc D2 at the lower playback unit 300
(5) inserting a disc D1 to be played back at the upper playback unit 200 (loading)
(6) holding the disc D1 to be played back at the upper playback unit 200
(7) putting aside the upper tray 401 before pivotal movement of the upper playback unit 200
(8) pivotally moving the upper playback unit 200
(9) placing onto the turntable 202 the disc al to be played back at the upper playback unit 200 (clamping)
(10) playing back the disc D1 at the upper playback unit 200
(11) releasing the disc D2 from the lower playback unit 300 (ejecting)

FIG. 15 and FIGS. 18 through 25 illustrate the operations from inserting a disc until playing back the disc in the upper playback unit 200 and the lower playback unit 300, each of which figures illustrates operation transitions, using relevant components of the device such as the upper playback unit 200, the lower playback unit 300, the upper tray 410, the lower tray 420, the leaf springs 411, 412, 421, and 422, the first screw members 510, the second screw member 520, and the discs D1 and D2.

[1] Operations of the Lower Playback Unit 300

(1) Inserting (loading) the Disc D2 (FIG. 15)

When the disc is to be inserted, the upper tray 410 engages with the cam-groove horizontal sections 5105 of the first screw members 510 and the cam-groove horizontal section 5205 of the second screw member 520.

The lower tray 420 engages with the cam-groove horizontal sections 5112 of the first screw members 510 and the cam-groove horizontal section 5213 of the second screw member 520, which makes the lower tray 420 tilt down its insertion slot side, resulting in easy insertion of the disc.

At this moment, the leaf springs 421 and 422 provided on the lower tray 420 are elastically deformed upwardly by a positional shift of the plate 405 in an arrow direction a shown in FIG. 11 and a pivotal movement of the plate 406 in an arrow direction c shown in FIG. 11, so that the disc D2 is inserted between the lower tray 420 and the leaf springs 421 and 422.

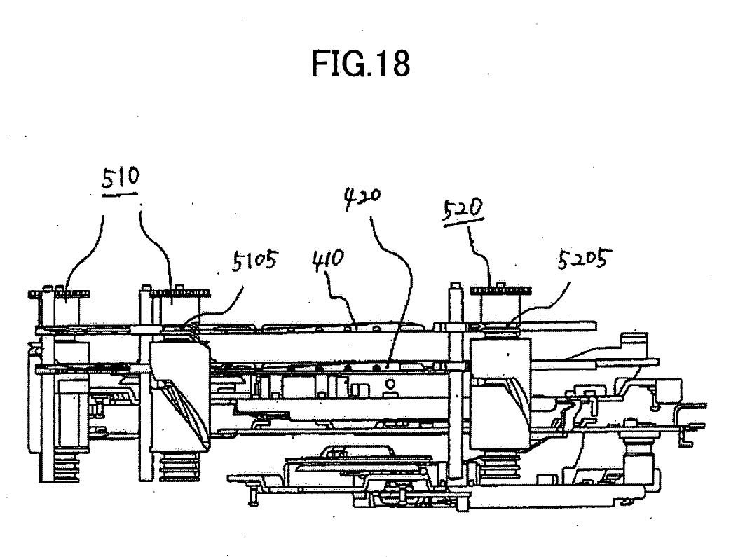

(2) Holding the Disc D2 (FIG. 18)

By rotating in a Y-direction shown in FIG. 15 the first screw members 510 and the second screw member 520, the upper tray 410 is lifted up to a level determined by the cam-groove horizontal sections 5105 and 5205 and the lower tray 420 is lifted up to a level determined by the cam-groove horizontal sections 5112 of the first screw members 510 and the cam-groove horizontal section 5212 of the second screw member 520.

This levels the lower tray 420; and by pivotally moving the cam gear 223 shown in FIG. 12 in synchronization with the above-described operations, the plate 405 moves in an arrow direction b shown in FIG. 11 and the plate 406 pivotally moves in an arrow direction d, which enables the leaf springs 421 and 422 to hold the disc.

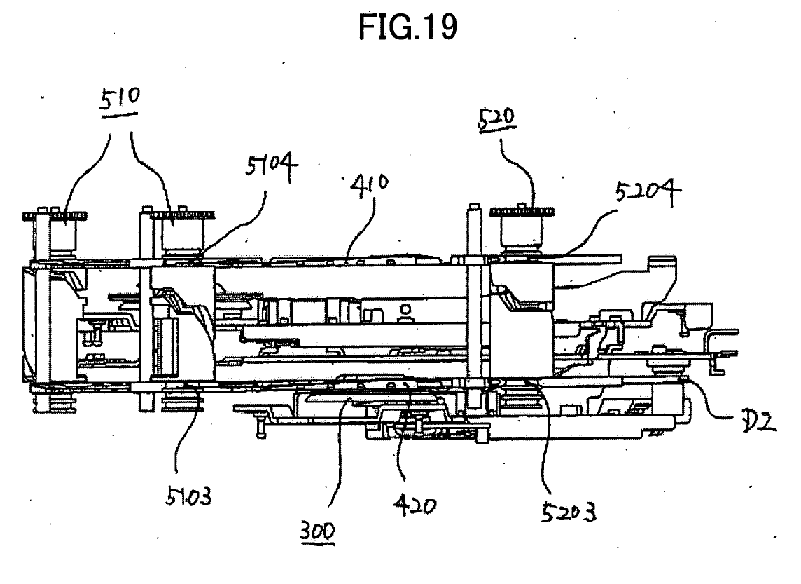

(3) Clamping the Disc D2 (FIG. 19)

By rotating in an X-direction shown in FIG. 15 the first screw members 510 and the second screw member 520, the upper tray 410 is lowered down to a level determined by the cam-groove horizontal sections 5104 of the first screw members 510 and the cam-groove horizontal section 5204 of the second screw member 520 and the lower tray 420 is lowered down to a level determined by the cam-groove horizontal sections 5103 of the first screw members 510 and the cam-groove horizontal section 5203 of the second screw member 520.

Then, the disc D2 is placed on the turntable 302 of the lower playback unit 300 and chucked (chucking mechanism is not illustrated in the figures). By this operation, the disc D2 is fixed on the turntable 302.

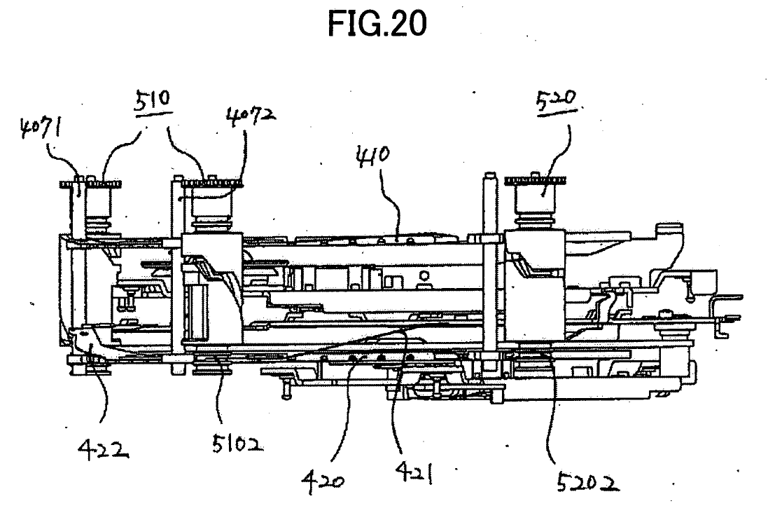

(4) Playing Back the Disc D2 (FIG. 20)

By rotating in the X-direction shown in FIG. 15 the first screw members 510 and the second screw member 520, the upper tray 410 is lowered down to a level determined by the cam-groove horizontal sections 5111 of the first screw members 510 and the cam-groove horizontal section 5211 of the second screw member 520, and the lower tray 420 is lowered down to a level determined by the cam-groove horizontal sections 5102 of the first screw members 510 and the cam-groove horizontal section 5202 of the second screw member 520.

At this moment, due to the rotation movements of the first screw members 510 and the second screw member 520, the cam gear 223 shown in FIG. 12 moves pivotally. By elastically deforming the leaf springs 421 and 422 through movements of the plates 405 and 406—similar movements described above, the lower tray 420 is set apart from the lower playback unit 300 and the disc D2 (its mechanism not shown in the figures).

Due to these operations, only the dampers 304 join the lower playback unit 300 to the deck chassis 100, enabling a stable disc playback without suffering from influences of external vibrations.

[2] Operations of the Upper Playback Unit 200

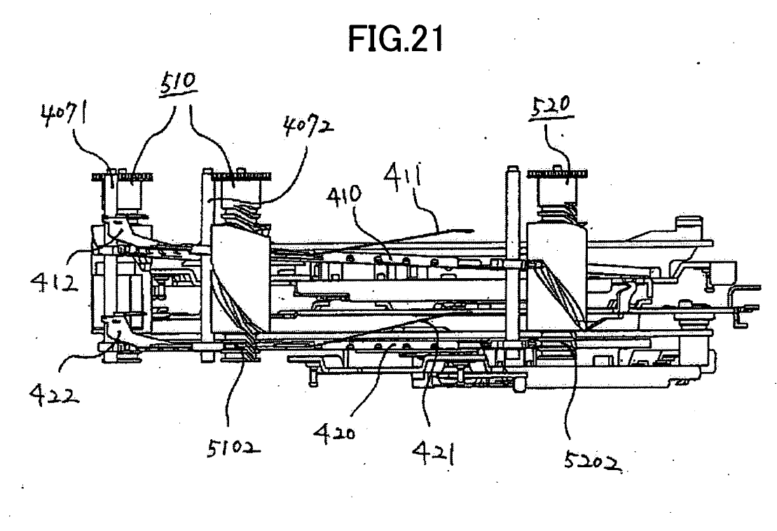

(1) Inserting (loading) the Disc D1 (FIG. 21)

By rotating in the X-direction shown in FIG. 15 the first screw members 510 and the second screw member 520, the upper tray 410 is lowered down to the cam-groove horizontal sections 5112 of the first screw members 510 and the cam-groove horizontal section 5213 of the second screw member 520, and the lower tray 420 is lowered down to a level determined by the cam-groove horizontal sections 5102 of the first screw members 510 and the cam-groove horizontal section 5202 of the second screw member 520.

Then, the upper tray 410 is in the same state as that of the lower tray 420 described at “(1) inserting (loading) the disc D2 (FIG. 15)”, which makes the disc D1 tilt down its insertion slot side, resulting in easy insertion of the disc D1,

The leaf springs 411 and 412 fixed on the upper tray 410 are also elastically deformed upwardly by the same movements of the plates 405 and 406, so that the disc D1 is inserted.

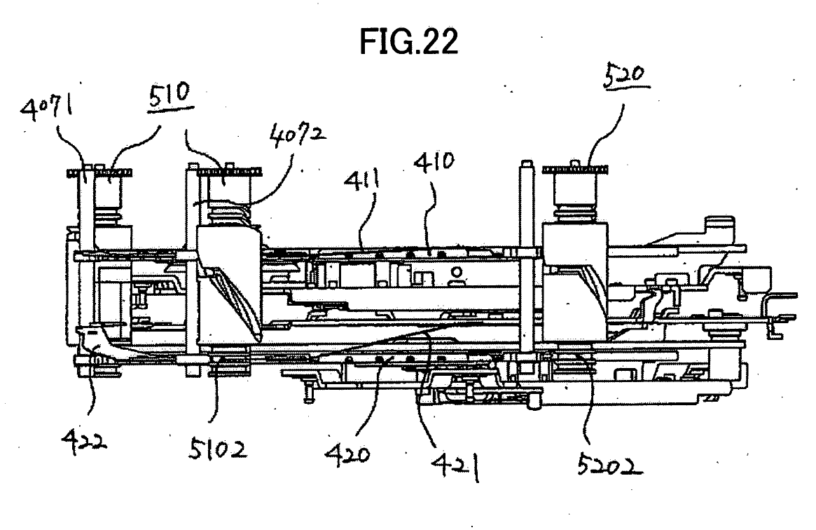

(2) Holding the Disc D1 (FIG. 22)

By rotating in the Y-direction shown in FIG. 15 the first screw members 510 and the second screw member 520, the upper tray 410 is lifted up to a level determined by the cam-groove horizontal sections 5112 of the first screw members 510 and the cam-groove horizontal section 5212 of the second screw member 520, and the lower tray 420 is lifted up to a level determined by the cam-groove horizontal sections 5102 of the first screw members 510 and the cam-groove horizontal section 5202 of the second screw member 520.

At this moment, the leaf springs 411 and 412 hold the disc D1 by movements of the plates 405 and 406 in the directions b and d shown in FIG. 11, respectively.

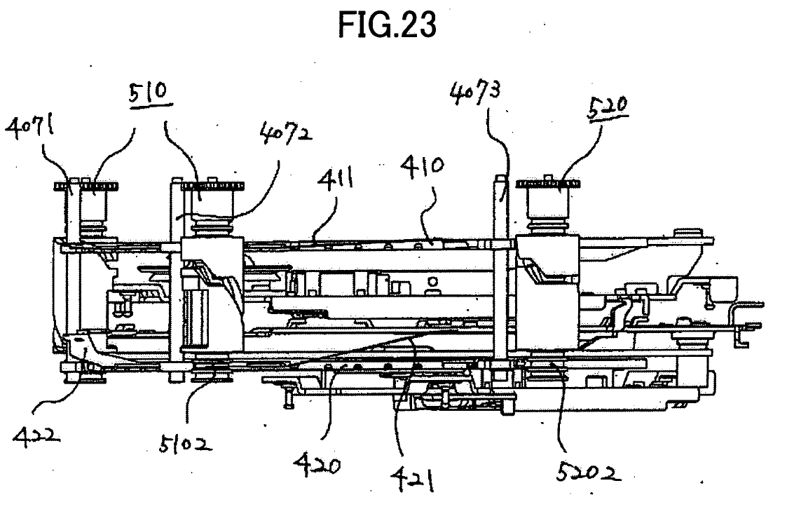

(3) Moving Aside the Upper Tray (FIG. 23)

By rotating the first screw members 510 and the second screw member 520 in the Y-direction shown in FIG. 15, the lower tray 420 is lifted up to the same height position as that in the state of the “(4) playing back the disc D2 (FIG. 20).”

Because lifting up of the upper tray 410 secures a height by which the upper playback unit 200 is not contact with the upper tray 410, the upper playback unit 200 can pivotally move up to a coaxial position of the disc D2 placed on the turntable 202, without being in contact with the upper tray 410.

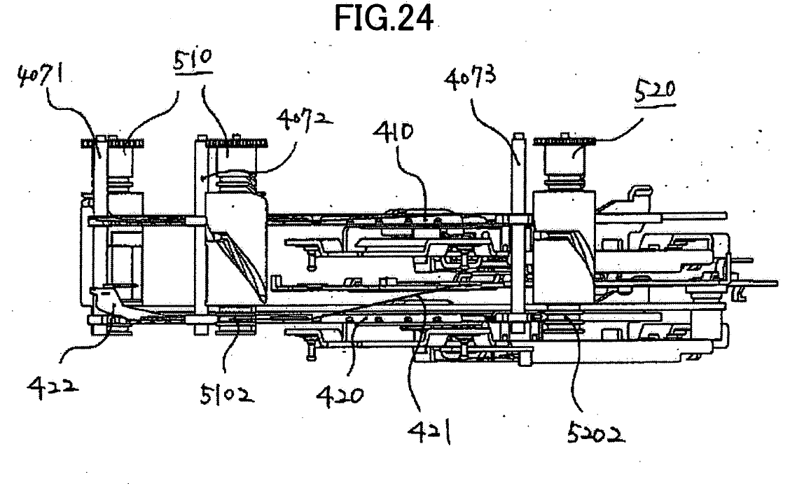

(4) Clamping the Disc D1 (FIG. 24)

By rotating the first screw members 510 and the second screw member 520 in the X-direction shown in FIG. 15, the lower tray 420 is lowered down to the same height position as that in the state of “(2) holding the disc D1 (FIG. 22).”

By this operation, the disc D1 on the upper tray 410 is placed on the turntable 202 of the upper playback unit 200 and chucked (chucking mechanism is not illustrated in the figures). The disc D1 is fixed on the turntable 202.

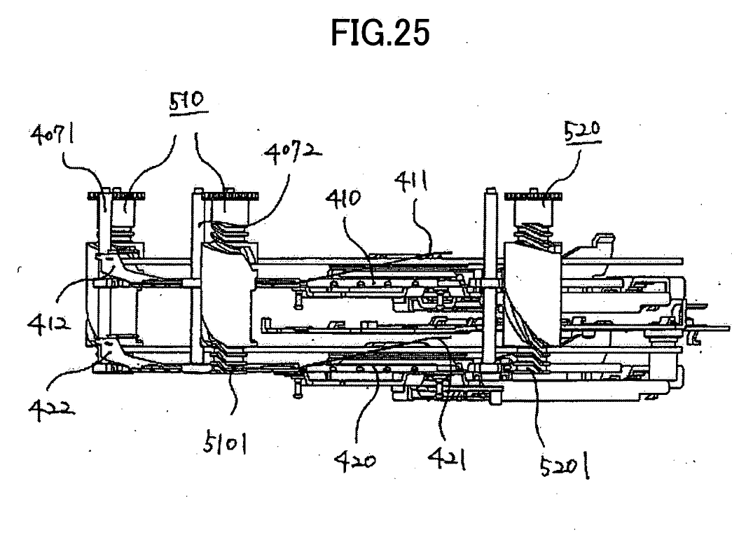

(5) Playing Back the Disc D1 (FIG. 25)

By rotating in the X-direction shown in FIG. 15 the first screw members 510 and the second screw member 520, the upper tray 410 is lowered down to a level determined by the cam-groove horizontal sections 5113 of the first screw members 510 and the cam-groove horizontal section 5213 of the second screw member 520, and the lower tray 420 is lowered down to a level determined by the cam-groove horizontal sections 5101 of the first screw members 510 and the cam-groove horizontal section 5201 of the second screw member 520.

At this moment, the leaf springs 411 and 412 provided on the upper tray 410 are elastically deformed upwardly by a positional shift of the plate 405 in the arrow direction a shown in FIG. 11 and a pivotal movement of the plate 406 in the arrow direction c shown in FIG. 11, so that the first tray 410 is set apart from the upper playback unit 200 and the disc D1. Due to these operations, only the dampers 204 join the upper playback unit 200 to the swing base 210, enabling a stable disc playback without suffering from influences of external vibrations.

During a period that starts with a disc loading operation for the upper playback unit 200 and ends with a starting operation of playing back the disc D1, the lower tray 420 stays at the cam-groove horizontal sections 5101 or 5102 of the first screw members 510 and the cam-groove horizontal section 5201 or 5202 of the second screw member 520; which always keeps the leaf springs 421, 422 and the lower tray 420 apart form the lower playback unit 300 and the disc D2, enabling the disc D2 to be continuously played back.

1-8. (canceled)

9. A storage medium playback device comprising:
a housing on which an insertion slot is formed for inserting therethrough a first storage medium and a second storage medium;
a first playback unit which is provided within the housing and plays back the first storage medium;
a second playback unit which is provided within the housing and plays back the second storage medium; and
a holding unit which is provided within the housing, carries to the first playback unit the first storage medium inserted through the insertion slot, and carries to the second playback unit the second storage medium inserted through the insertion slot; wherein,
the first playback unit is configured to pivot around a pivoting axis provided at a corner within the housing and pivots substantially on a face parallel to the first storage medium that is inserted from the insertion slot, the first playback unit pivots towards a central portion of the housing when the holding unit carries the first storage medium to the first playback unit, and the first playback unit pivots towards an inner face of the housing when the holding unit carries the second storage medium to the second playback unit and when the holding unit ejects the second storage medium from the second playback unit.

10. The storage medium playback device according to claim 9, wherein the second playback unit is fixed to a portion of the storage medium playback device.

11. The storage medium playback device according to claim 9, wherein the first playback unit is positioned substantially coaxial with the second playback unit when the first storage medium is played back.

12. The storage medium playback device according to claim 9, wherein the second playback unit is provided at a bottom of the storage medium playback device, and the first playback unit is provided above the second playback unit.

13. The storage medium playback device according to claim 9, wherein the holding unit includes:
a first carrier tray that holds the first storage medium,
a second carrier tray that holds the second storage medium, and
a movement mechanism that moves, based on operation states of the first playback unit and the second playback unit, the first carrier tray and the second carrier tray perpendicularly to a plane on which the first storage medium or the second storage medium is being played back, and
wherein when the first storage medium is carried to the first playback unit, the movement mechanism moves the first carrier tray towards the first playback unit, and when the second storage medium is carried to the second playback unit, the movement mechanism moves the second carrier tray towards the second playback unit.

14. The storage medium playback device according to claim 13, wherein the movement mechanism includes one or more screw members that are rod-shaped and on each of which a groove is formed to determine, in accordance with rotation angles of the one or more screw members, setting positions for the first carrier tray and the second carrier tray.

15. The storage medium playback device according to claim 14, wherein a plurality of the one or more screw members are provided at a plurality of positions to support the first carrier tray and the second carrier tray, and
wherein when the first storage medium inserted through the insertion slot is placed on the first carrier tray, the one or more screw members each support the first tray at different heights so that a face of the first carrier tray, which the first storage medium is brought into contact with, inclines towards the insertion slot, and
when the second storage medium inserted through the insertion slot is placed on the second carrier tray, the one or more screw members each support the second tray at different heights so that a face of the second carrier tray, which the second storage medium is brought into contact with, inclines towards the insertion slot.

16. The storage medium playback device according to claims 9, further comprising
a memory which stores and outputs playback information which the first playback unit obtains from the first storage medium through its playback operation, wherein when the second storage medium loaded on the second playback unit is to be ejected while the first playback unit is playing back, the playback operation of the first playback unit is temporarily suspended and the first storage medium whose playback operation is suspended is moved to a position so that the second storage medium is capable of being ejected, and then the second storage medium is ejected from the insertion slot while the memory continuously outputs the playback information during a period when the playback operation of the first playback unit is suspended.

17. The storage medium playback device according to claims 11, further comprising a memory which stores and outputs playback information which the first playback unit obtains from the first storage medium through its playback operation, wherein when the second storage medium loaded on the second playback unit is to be ejected while the first playback unit is playing back, the playback operation of the first playback unit is temporarily suspended and the first storage medium whose playback operation is suspended is moved to a position so that the second storage medium is capable of being ejected, and then the second storage medium is ejected from the insertion slot while the memory continuously outputs the playback information during a period when the playback operation of the first playback unit is suspended.

18. The storage medium playback device according to claims 12, further comprising a memory which stores and outputs playback information which the first playback unit obtains from the first storage medium through its playback operation, wherein when the second storage medium loaded on the second playback unit is to be ejected while the first playback unit is playing back, the playback operation of the first playback unit is temporarily suspended and the first storage medium whose playback operation is suspended is moved to a position so that the second storage medium is capable of being ejected, and then the second storage medium is ejected from the insertion slot while the memory continuously outputs the playback information during a period when the playback operation of the first playback unit is suspended.

19. The storage medium playback device according to claim 11, wherein the second playback unit is provided at a bottom of the storage medium playback device, and the first playback unit is provided above the second playback unit.

20. The storage medium playback device according to claims 19, further comprising a memory which stores and outputs playback information which the first playback unit obtains from the first storage medium through its playback operation, wherein when the second storage medium loaded on the second playback unit is to be ejected while the first playback unit is playing back, the playback operation of the first playback unit is temporarily suspended and the first storage medium whose playback operation is suspended is moved to a position so that the second storage medium is capable of being ejected, and then the second storage medium is ejected from the insertion slot while the memory continuously outputs the playback information during a period when the playback operation of the first playback unit is suspended.
